(19) United States
(12) Patent Application Publication
(10) Pub. No.: US 2024/0394284 A1
(43) Pub. Date: Nov. 28, 2024

(54) Query-Based Document Extraction with Large Vision-Language Models

(71) Applicant: Google LLC, Mountain View, CA (US)

(72) Inventors: Daniel Vlasic, Cambridge, MA (US); Yiming Gu, Glenshaw, PA (US); Daniel Hernandez Diaz, Mountain View, CA (US); Ilaï Deutel, Pittsburgh, PA (US); Xi Xiong, Santa Clara, CA (US); Tianli Yu, Sunnyvale, CA (US); Joseph Pagadora, San Francisco, CA (US); Mingyang Ling, Sunnyvale, CA (US); Jill Daley, Brooklyn, NY (US); Guolong Su, Houston, TX (US)

(21) Appl. No.: 18/386,803

(22) Filed: Nov. 3, 2023

Related U.S. Application Data
(60) Provisional application No. 63/468,173, filed on May 22, 2023.

(51) Int. Cl. G06F 16/332; G06F 40/40; G06T 7/11; G06V 30/414

(52) U.S. Cl. CPC G06F 16/3329; G06F 40/279; G06F 40/40; G06T 7/11; G06V 30/414

(57) ABSTRACT

An aspect of the disclosed technology is a system and process that are able to answer a document query as text and also provide the location in an image where the answer text is detected. In one aspect of the disclosed technology, a machine learning model combines vision and language features for joint learning.

### CROSS REFERENCE TO RELATED APPLICATIONS

The present application claims the benefit of the filing date of U.S. Provisional Patent Application No. 63/468,173, filed on May 22, 2023, the disclosure of which is hereby incorporated herein by reference.

### BACKGROUND

Cloud customers have been using Document AI processors to extract information from a variety of documents, spanning financial, government, and health domains. This is generally referred to as entity extraction, which is generally considered a core task of document understanding technology. In such systems, a user is, for example, interested in extracting “Customer Name” from a document and the system is expected to return “John Doe.” Most processors are specific to a particular document type (e.g., a W-2 form) and have been trained on large amounts of manually labeled data. Customers can also label their own data and train custom processors specific to their use cases, but this can be time-consuming and expensive. Furthermore, specialized processors are limited to the documents and entities they have been trained on, and cannot be applied to different document or entity types without further labeling and training.

For instance, one approach to providing this technology involves marking the locations of all entities of interest in a template document. For documents that follow the same layout, marked entities may be extracted; however, where there are layout variations or new layouts, the template oftentimes becomes ineffective. In addition, Large Language Models (LLMs) may be used to answer generic questions using optical character recognition (OCR) technology, but do not exploit the two-dimensional layout of a document and/or document appearance.

### SUMMARY

Aspects of the disclosed technology may take the form of processes, methods, computing devices and/or computing systems. For example, an aspect of the disclosed technology is a system and/or process that is able to answer a document query as text and also provide the location in an image where the answer text is detected.

For example, the disclosed technology may comprise a process for querying one or more documents. The process includes receiving a document query including a natural language query and information identifying one or more document images; processing the document query in a machine learning model, the machine learning model being trained using language features and vision features for joint learning; and generating an answer based on processing of the document query by the machine learning model, the answer including text and a bounding box indicating a location of the source of the answer.

In accordance with this aspect of the disclosed technology, the language features may be associated with a large language model (LLM). Further in accordance with this aspect of the disclosed technology, the vision features are associated with a large vision model such as a Vision Transformer (ViT).

Further in accordance with this aspect of the disclosed technology, the machine learning model may be based on a unified language-image model, such as for example the PaLI (Pathways Language and Image) model. In some examples, the model may be further pretrained and/or fine-tuned using one or more image-text datasets and tasks. Further, the one or more datasets may include key-value pair data, specific entity data or generic entity data.

Further in accordance with this aspect of the disclosed technology, the language-image model is fine-tuned to predict text in a bounding box. In accordance with the disclosed technology, we refer to this model as a FormPaLI model. The bounding box can be specified by two corner coordinates for an axis-aligned bounding box. In general, it can be any list of polygon vertices.

In accordance with this aspect of the disclosed technology, the FormPaLI model uses machine learning inferences to make predictions on new data. Further, the FormPaLI model uses GPU or TPU inferences.

Further in accordance with this aspect of the disclosed technology, processing may comprise applying optical character recognition (OCR) to the one or more document images. In this regard, processing may also comprise partitioning the one or more document images into different regions. Further, processing may comprise resampling images associated with the different regions.

In accordance with this aspect of the disclosed technology, processing may comprise verifying the answer against optical character recognition (OCR) generated text and one or more location parameters. Further, the location parameters define the bounding box.

In accordance with this aspect of the disclosed technology, the machine learning model may be pretrained by masking spans of optical character recognition (OCR) serialized text and requesting the machine learning model to predict the spans of masked OCR serialized text. Further, the machine learning model may be pretrained by instructing the model to predict the line above, below, to the left and to the right of a given item of text.

In accordance with this aspect of the disclosed technology, the natural language query may comprise written text or an audible question.

As another example, the disclosed technology may comprise a computing device. The computing device may be configured to perform certain tasks in response to a prompt and provide output based on the prompt. The tasks can take the form of one or more instructions that cause the computing device to perform certain functions or are used to program the computing device to perform such functions. Those functions may comprise functions that implement the foregoing processing steps or features discussed above in relation to the process discussed above for querying one or more documents. Those processing steps or features may comprise instructions that cause a processing element of the processing device to operate so as to apply the machine learning model in response to the prompt and provide the foregoing output.

As another example, the disclosed technology may comprise non-transitory computer readable media that contain one or more instructions that cause a computing device to operate so as to perform the processes or steps discussed above in relation to the process for querying one or more documents.

As another example, the disclosed technology may comprise a system. The system may include one or more of the foregoing computing devices that are programmed to perform the processes or steps discussed above in relation to the process for querying one or more documents. In this regard, the system may comprise a cloud computing system in which such computing devices are distributed in an architecture that allows customers to access or use the process for querying one or more documents as a service.

More specifically, the disclosed technology may comprise a system for querying one or more documents, comprising: one or more processing devices; a memory storing instructions and coupled to the one or more processing devices, the instruction causing the one or more processing devices to: receive a document query including a natural language query and information identifying one or more document images; process the document query in a machine learning model, the machine learning model being trained using language features and vision features for joint learning; and generate an answer based on processing of the document query by the machine learning model, the answer including text and a bounding box indicating a location of the source of the answer.

In accordance with this aspect of the disclosed technology, the system process the document query by: applying optical character recognition (OCR) to the one or more document images to produce OCR generated text; partitioning the one or more document images into different regions; and verifying the answer against the OCR generated text and a location parameter.

### BRIEF DESCRIPTION OF THE DRAWINGS

FIG. 1 illustrates an example process or method in accordance with an aspect of the disclosed technology.

FIG. 2A illustrates an example process or method in accordance with an aspect of the disclosed technology.

FIG. 2B illustrates an example process or method flow architecture in accordance with an aspect of the disclosed technology.

FIG. 3 illustrates an example processor architecture in accordance with an aspect of the disclosed technology.

FIG. 4 illustrates a processing flow associated with the machine learning model in accordance with an aspect of the disclosed technology.

FIG. 5 illustratively depicts an example computing device in accordance with an aspect of the disclosed technology.

FIG. 6 illustratively depicts an example computing system in accordance with an aspect of the disclosed technology.

### DETAILED DESCRIPTION

An aspect of the disclosed technology is a system and/or process that is able to answer a document query as text and also provide the location in an image where the answer text is detected. Detecting the location of the answer in the document image adds a layer of explainability. This allows for a better level of confidence in the answers provided, accounting for hallucinations and optical character recognition (OCR) errors. In this regard, an aspect of the disclosed technology involves applying detection of object instances (e.g., cars) to specific text entities in documents. For example, the disclosed technology uses a language and image model that is fine-tuned on document data so as to improve its OCR capabilities and layout understanding. In addition, the model is trained to predict an image location (e.g., a bounding box) in addition to the answer text for each query. This allows verification that the answer is coming from the appropriate section of the document, allows comparison of the answer to that of the specialized OCR engine, and allows for better estimation of the confidence level of any particular output.

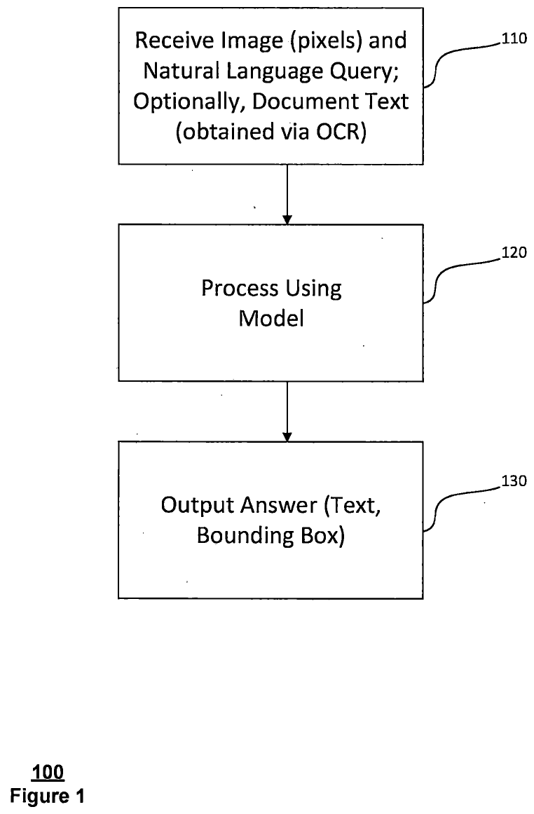

FIG. 1 is a process or method 100 in accordance with an aspect of the disclosed technology. The process 100 starts at step 110 with receipt of a query relating to one or more documents. The query can include natural language and/or image queries and may include identification of one or more documents that are the subject to the query. In some examples, the natural language query may take the form of an audible question or written text. In some examples, the documents may comprise forms that a customer (e.g., a business entity) needs processed so that certain entity information is extracted.

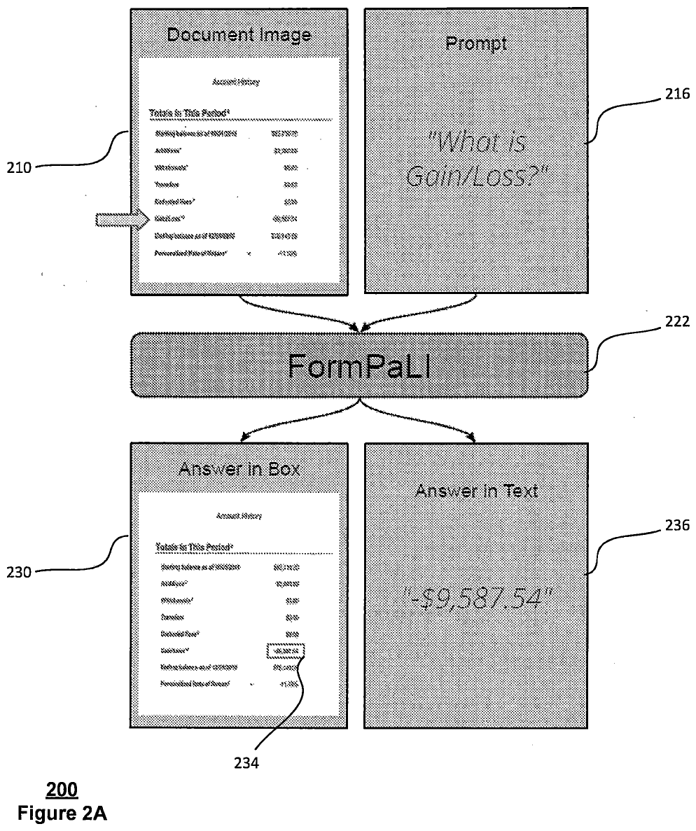

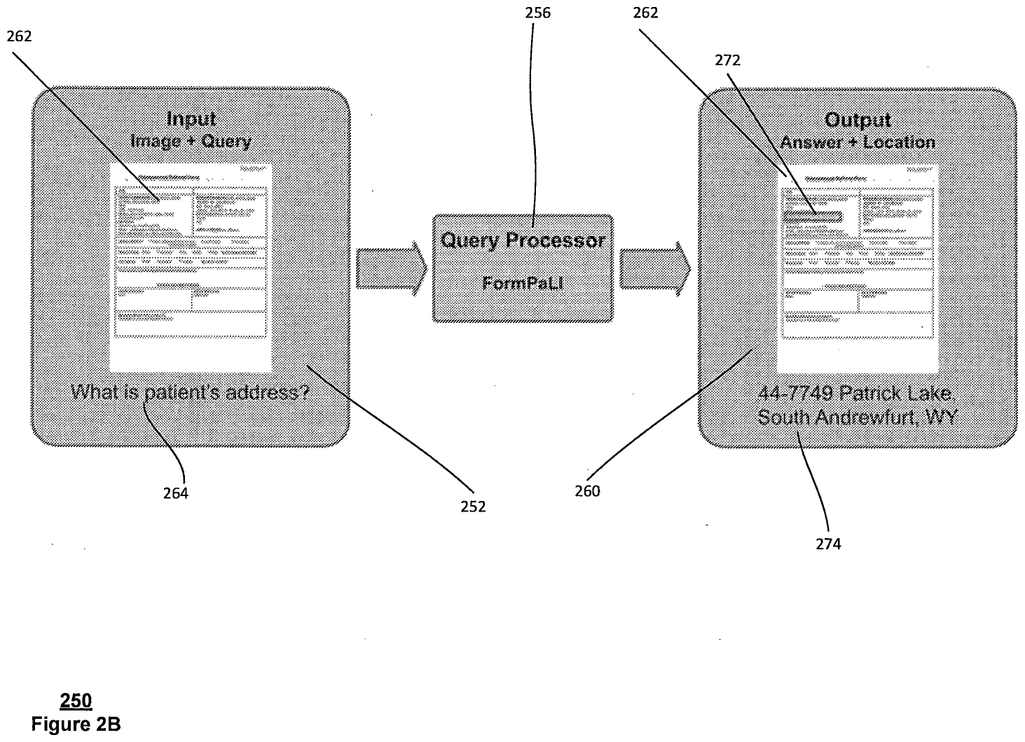

For example, as shown in FIG. 2A, the document may comprise a document image 210 having certain financial information. More specifically, the document or document image 210 includes account history for some time period. The account history includes information associated with an account such as starting balance, additions, withdrawals, and gain/loss. The natural language query or prompt 216 comprises the question “What is Gain/Loss?”

The query is then processed using a model at step 120. As indicated above, the model is a language-image model that is fine-tuned on document data. The model is a machine learning model that may be based on a unified language-image model, such as for example the PaLI (Pathways Language and Image) model. In some examples, the model may be further pretrained and/or fine-tuned using one or more image-text datasets and tasks. Further, the one or more datasets may include key-value pair data, specific entity data or generic entity data.

In the example shown in FIG. 2, the model 222 is based on the large language-image model PaLI (Pathways Language and Image model). FormPaLI improves on the PaLI model and further fine-tunes it on document data for document understanding. The query is processed by the model 222 so as to provide an answer.

At step 130, the answer is outputted as text and a bounding box. In keeping with the example of FIG. 2A, the output may take the form of an answer in a box 230 and an answer in text 236. The answer in a box 230 includes a bounding box 234 around the Gain/Loss. The bounding box can be specified by two corner coordinates for an axis-aligned bounding box as shown by bounding box 234. The bounding box, however, can be any list or combination of polygon vertices. The answer in text 236 includes the answer as the actual value responsive to the query, e.g., −$9,587.54.

FIG. 2B illustratively depicts a high-level process flow 250 showing a sample input 252, a query processor 256 and a sample output 260. The sample input includes a document image 262 and a query 264 (“What is the patient's address?”). In general, the query takes the form of a natural language query. Query processor 256 takes the document image 262 and query 264, process them using the FormPali model and provides output 260. As shown, output 260 includes a bounding box 272 appended to the document image 262 and an answer 274. Query processor 256 enables extraction of information from documents using natural language queries using the FormPaLI model. Query processor 256 may operate, for example, on any form-like document without the need for labeled data based on it understanding of text and layout.

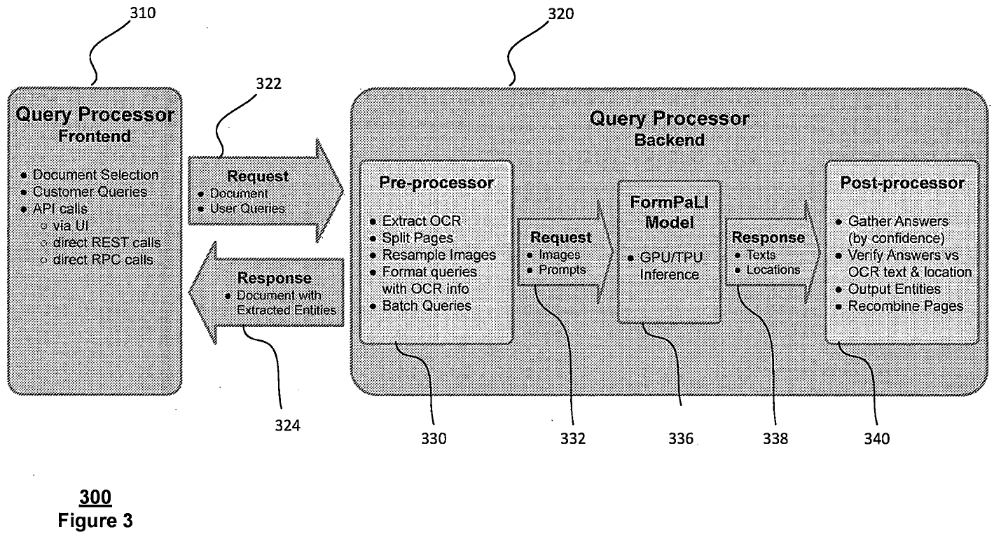

FIG. 3 illustrates an example architecture 300 for processing queries in accordance with an aspect of the disclosed technology. Architecture 300 is referred to as a document AI query processor 300. The processor architecture 300 is an example of a zero-shot entity extraction model, e.g., it provides a mechanism to extract entities that are not captured (well or at all) by pretrained models. That model is powered by a joint language-image model, such as FormPaLI. Using document AI query processor 300, users query a document and receive desired values with bounding box location information alongside pretrained model output (e.g., Form Parser, Invoice, etc.) to improve (e.g., optimize) their extraction pipeline. Document AI query processor 300 can be implemented so as to allow users to prompt design, evaluate with a test dataset, and power extraction pipelines without training data.

Document AI query processor 300 includes a query processor frontend 310 and a query processor backend 320. The query processor frontend 310 sends request 322 to and receives response 324 from the query processor backend 320. Request 322 includes identification of the document(s) subject to the user query(ies), as well as the user query(ies). The response 324 includes the document(s) with the extracted entities.

Query processor frontend 310 allows for document selection and queries by a customer. Such functionality may be implemented via an application programming interface (API) that functions as an intermediary layer that processes data transfer between a customer system and the query processor frontend 310. API calls may be inputted via a user interface (UI) and may take the form of direct Representation State Transfer (RST) calls or remote procedure calls (RPCs).

Query processor backend 320 includes a pre-processor 330. Pre-processor 330 performs a number of functions. One function includes performing optical character recognition (OCR) on the documents provided or identified as part of the request so as to extract OCR characters. Another function performed by pre-processor 330 is split pages, which partitions the document page into different regions. Another function is to resample the images. Once the foregoing functions are completed, a prompt is formatted by combining the query text, the OCR text, and the resampled image. The query(ies) is/are then batched for further processing. Each of the foregoing functions will typically be performed serially, but one skilled in the art would appreciate that they need not be performed in the exact order described. For instance, the functions may be performed in parallel up to the point where information is gathered into a model prompt.

Following pre-processing, the request is formatted as including one or more images along with prompts, as shown at request 332. Request 332 is fed to a FormPaLI model 336, where it is processed to produce a response 338, which includes texts and location information (see, for example, FIG. 2). FormPaLI model 336 may use a GPU (graphics processing unit) or TPU (tensor processing unit) inference engine in responding to queries to extract entities that are not captured (either exactly or without variation) during pre-training. FormPaLI model 336 comprises, generally, a large vision model tuned for document understanding. For example, given an image of a document and a natural language query (e.g., “What is seller's address?”), the model predicts the answer text (“/Main Street”) along with the corresponding bounding box.

Response 338 is fed to post-processor 340. Post-processor 340 gathers answers, verifies answers against OCR text and location, outputs entities, and recombines pages. Given a prompt, the FormPaLI model may produce multiple outputs using beam search (e.g., with the number of beams to 5). Each output is accompanied by a score that can be turned into confidence. The top output may be picked based on majority voting, accumulating the confidences of all equivalent outputs, where equivalence compares answer texts without bounding boxes. The chosen output encodes one or more answers, each comprising of text and bounding box. The output may be parsed to get a list of (answer_text, bounding_box) pairs and turn them into document entities. When querying a document for multiple entities, answers whose values overlap in the image can occur. For example, a model may conflate home phone and cell phone if only one of them is present. In this case, the most confident answer may be kept. For multi-page documents, all queries on each page are executed and all resulting entities are accumulated. This process may be further optimized if certain queries are known to only appear on specific pages, either from prior knowledge or by finding key phrases in the text of a page.

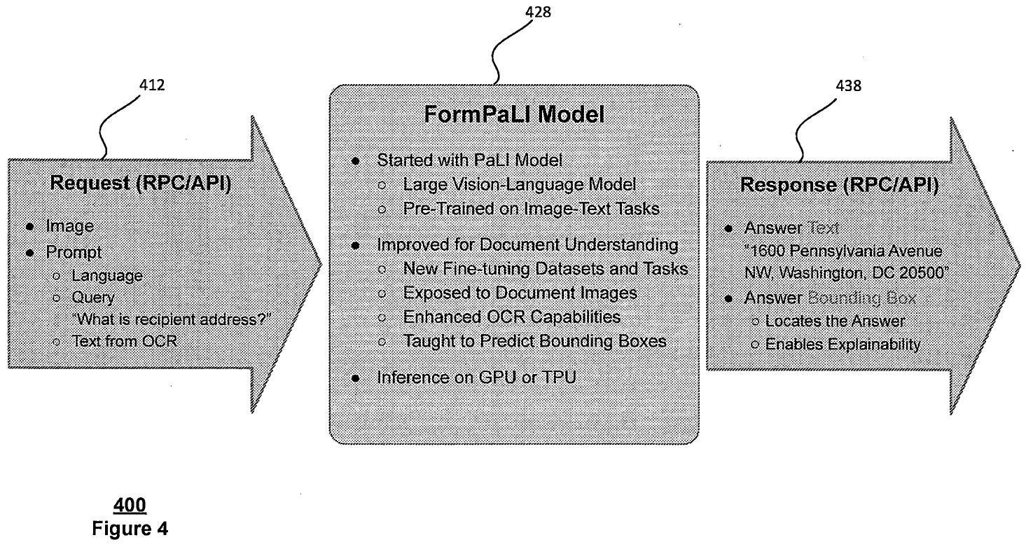

FIG. 4 illustrates a process flow 400 associated with the FormPaLI model. The flow includes request 412 being processed by the FormPaLI model 428 to produce response 438. Request 412 includes a document image and a prompt. The prompt includes a natural language query, e.g., “What is recipient address?” The prompt also includes text resulting from the OCR of the document image. As shown, in this example the request is in the form of an RPC call issued via an API.

The request 412 is processed using the FormPaLI model component or module 428. As indicated, the FormPaLI model is a large vision-language model that is pre-trained on image-text tasks. The FormPaLI model is improved for document understanding in different ways. For example, FormPaLI is fine-tuned on new datasets and tasks. Furthermore, our fine-tuning tasks condition the model to predict both the answer text and the corresponding bounding box, yielding a novel hybrid Detection-VQA paradigm that is well suited to document processing. It is also exposed to document images and includes enhanced OCR capabilities. Further, it is taught to predict bounding boxes. In addition, it uses machine learning inference (e.g., GPU or TPU inference) to make predictions on new or novel data.

FormPaLI entity instruction may be viewed as a combination of detection and visual question answering (VQA) tasks. The FormPaLI model 428 prompts are generally structured using two tasks as follows:
“Extract in {language}: What is {query phrase}<extra_id_0>{ocr_text}”
“Extract in {language}: List of {query phrase}<extra_id_0> {ocr_text}”
where:
   “Extract” instructs the model to perform the task of predicting both answers and their bounding boxes.
   “Language” comprises a two-letter language code (e.g., EN) that adds multi-lingual support.
   “What is” indicates that the query expects a single answer.
   “List Of” indicates that the query exceeds multiple answers (e.g., entries of a table column).
   “query_phrase” comprises a nominal phrase describing the entity to extract.
   “<extra_id_0>” comprises a token marking the end of the query.
   “ocr_text” comprises an optional list of OCR blocks, lines, or tokens separated by a special token “</s>”. The presence of document text in the prompt improves the quality of the resulting entity values.

The FormPaLI output format is also based on the two tasks discussed above:

```
  “<extra_id_0> {top} {left} {bottom} {right} {answer_text}”
  “<extra_id_0> {top_1} {left_1} {bottom_1} {right_1} {answer_text_1} <extra_id_0>
{top_2} {left_2} {bottom_2} {right_2} { answer_text_2}”
```

where:
   <extra_id_0> comprises a token marking the start of each answer (allowing for multiple answers per query).
   top, left, bottom, right are the corners of the detected bounding box relative to page dimensions, represented as integers in 0-1000 range.
   answer_text holds the value of the queried entity.

Examples of prompts and outputs may comprise the following:
Prompt: “Extract in EN: What is recipient's name <extra_id_0> Invoice ID123132</s> . . . ”
Output: “<extra_id_0>100 80 108 200 John Smith”
Prompt: “Extract in EN: List of line item amounts <extra_id_0> Invoice ID123132</s> . . . ”
Output: “<extra_id_0>400 120 410 200 $1,234.00<extra_id_0>420 150 430 200 $100.00”

FormPaLI is tuned on several Document AI datasets spanning multiple document types: invoices, receipts, utility bills, government forms, and bank statements. We focus on the following kinds of entities: key-value pairs, specific entities, and generic entities. Example datasets include the following:

### Key-Value Pair Data

A key-value pair is any piece of information where the key phrase is mentioned in the document along with its value. For example, a clinical form may contain “Patient name: John Doe” where “Patient name” is the key phrase and “John Doe” is the corresponding value. A training example format may comprise:
Query
   Format: “What is {key_phrase}?”
   Example: “What is 17 State income tax?”
Answer
   Format: “{bounding_box} {value}”
   Example: “50 200 70 300 $1,000.00”
   “<empty>” for negative examples

Key-value pair data may comprise various labeled and synthesized documents such, as for example, invoices, government forms, bills, paystubs, etc.

### Specific Entity Data

Specific entities correspond to entity types listed in the schemas of Document AI datasets for various document types. Schema is a document AI mechanism useful in defining a list of entities of interest and their properties (e.g., patient_address may be an entity type, and address its corresponding type). They correspond to domain specific quantities (such as sender_name or receiver_address) and may not have the corresponding key phrase mentioned in the document. A training example format may comprise:
Query
   Format: “What is {entity_type}?”
   Example: “What is supplier address?”
Answer
   Format: “{bounding_box} {entity_value}”
   Example: “50 20 70 80 1 Main St.\n New York, NY 12345”
   “<empty>” for negative examples

Specific entity data may comprise various labeled and synthesized documents such as for example invoices, government forms, bills, paystubs, etc.

### Generic Entity Data

Generic entities include concepts such as names, addresses, or emails. They can be thought of as higher-level groupings of specific entities (e.g., customer_address and supplier_address would both fall under the generic address). Hence, there may be multiple occurrences of a generic entity in a document, even though there is only one occurrence for each specific entity of the compatible type. Generic entity data may comprise various labeled and synthesized documents such as for example invoices, government forms, bills, paystubs, etc.

Fine-tuning enables FormPaLI's ability to predict locations along with textual values. Fine-tuning tasks condition the model to recognize custom prompts and respond with answers that prefix the values with the list of corresponding bounding box corners. They operate on a corpus of several human-labeled datasets spanning key-value pairs, entities, and tables.

Fine tuning may comprise the following tasks associated with each of the foregoing:

### Key-Value Pair Task

The model is instructed or enabled to predict the value for a given key phrase in the Key-Value Pair Data by, for example, providing training examples of the kind discussed above in the key-value pair data section. As a result, this task enables the model to detect the phrase in the document and extract its associated value. For positive examples, the key phrase and its value explicitly appear in the document, but due to the underlying language model, even paraphrasing the key phrase should yield the same value. It is equally important to discern when keys are present without values (e.g., an empty form field), which we achieve using negative examples in training (answers for such keys should be empty).

### Specific Entity Task

The model is instructed or enabled to predict values of entity types in the Specific Entity Data, by, for example, providing training examples of the kind discussed above in the specific entity data section. Leveraging these fine-grained entity types enhances the model's ability to differentiate between similar entities, such as invoice_date vs. due_date and employee_name vs. employer_name. Since entity types do not match their mentions in the document (e.g., invoice_id may be referred to as “invoice #”), this task improves FormPaLI's understanding of synonyms and acronyms. Furthermore, since some entities are not explicitly mentioned in the text (e.g., a keyless address beneath employer_name would be employer_address), this task improves the understanding of the layout context.

### Generic Entity Task

The model is instructed or enabled to extract all occurrences of a generic entity type in the Generic Entity Data, or enabled to predict values of entity types in the Specific Entity Data, by, for example, providing training examples of the kind discussed above in the generic entity data section. This teaches it to predict multiple answers for one query. Generic entities have much larger coverage than specific entities and reinforce the model's understanding of common concepts such as names, addresses, emails, etc.

Pre-training can further improve the efficacy of fine-tuning by adapting the model to the target data distribution of layout-rich documents. This can both speed up the fine-tuning and increase the performance of the final model. The proposed pre-training tasks can be batched into multiple query-answer pairs per example to potentially enhance performance and efficiency. Pretraining tasks may include the one or more of the following:

### Span Corruption

Span corruption involves masking random spans of OCR serialized text, and ask the model to predict them. For instance, 7% of the tokens may be masked. However, in some examples that percentage may be lower (e.g., 2%-7%) or higher (above 7%). We can optionally also mask the corresponding bounding box in the image, or the whole image. The main focus of this task is on enhancing the language model component.

### Neighboring Text Prediction

Given the text of an OCR line, the model is asked to predict the line above, below, to the left, or to the right of it. As the corresponding key and value often have vertical or horizontal alignment in the document, the neighboring text prediction could adapt the model to this pattern for downstream fine-tuning tasks.

### Text to Bounding Box

The model is instructed to predict the text contained in a bounding box, specified by two corner coordinates, thus improving the detection of text in images.

### Bounding Box to Text

The model is instructed to predict the bounding box corner coordinates of a text span. This may help the model to refine the accuracy of coordinate prediction as used by our fine-tuning tasks.

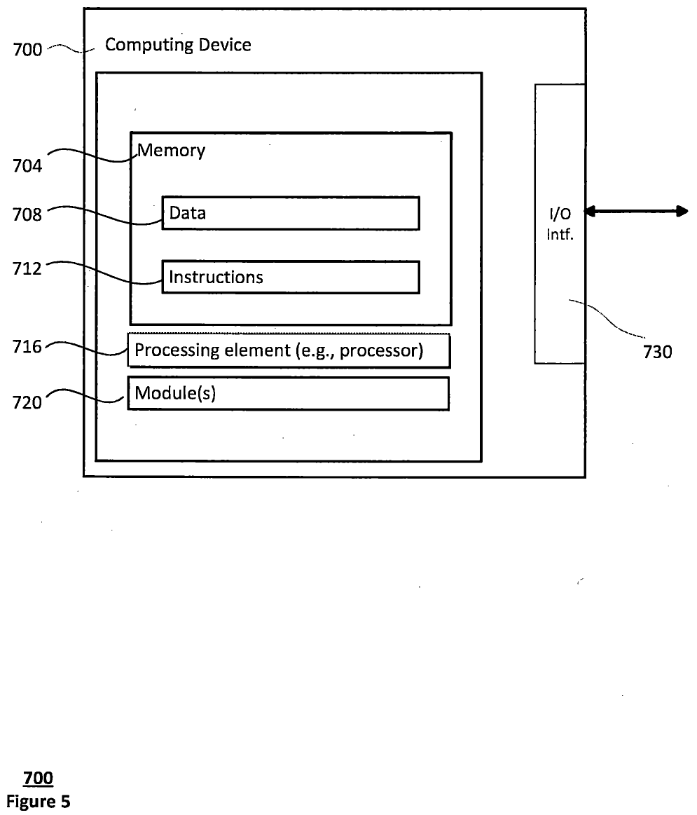

FIG. 5 depicts an example computing device 700 that may be used to carry out various aspects of the disclosed technology. For example, the computing device 700 may be used to implement the processes discussed above, including the process depicted in FIGS. 1, 2A, 2B, 3 and 4, and the various processing associated with the components and modules shown or discussed in relation to those figures. In addition, computing device may comprise any one of the query processor 256, frontend 310, or backend 320 query processors.

The computing device 700 can take on a variety of configurations, such as, for example, a controller or microcontroller, a processor, or an ASIC. In some instances, computing device 700 may comprise a server or host machine that carries out the operations discussed above. In other instances, such operations may be performed by one or more computing devices in a data center. The computing device may include memory 704, which includes data 708 and instructions 712, and a processing element 716, as well as other components typically present in computing devices (e.g., input/output interfaces for a keyboard, display, etc.; communication ports for connecting to different types of networks).

The memory 704 can store information accessible by the processing element 716, including instructions 712 that can be executed by processing element 716. Memory 704 can also include data 708 that can be retrieved, manipulated, or stored by the processing element 716. The memory 704 may be a type of non-transitory computer-readable medium capable of storing information accessible by the processing element 716, such as a hard drive, solid state drive, tape drive, optical storage, memory card, ROM, RAM, DVD, CD-ROM, write-capable, and read-only memories. The processing element 716 can be a well-known processor or other lesser-known types of processors. Alternatively, the processing element 716 can be a dedicated controller such as an ASIC.

The instructions 712 can be a set of instructions executed directly, such as machine code, or indirectly, such as scripts, by the processor 716. In this regard, the terms “instructions,” “steps,” and “programs” can be used interchangeably herein. The instructions 712 can be stored in object code format for direct processing by the processor 716, or can be stored in other types of computer language, including scripts or collections of independent source code modules that are interpreted on demand or compiled in advance. For example, the instructions 712 may include instructions to carry out the methods and functions discussed above in relation to processing query-based document extractions.

The data 708 can be retrieved, stored, or modified by the processor 716 in accordance with the instructions 712. For instance, although the system and method are not limited by a particular data structure, the data 708 can be stored in computer registers, in a relational database as a table having a plurality of different fields and records, or in XML documents. The data 708 can also be formatted in a computer-readable format such as, but not limited to, binary values, ASCII, or Unicode. Moreover, the data 708 can include information sufficient to identify relevant information, such as numbers, descriptive text, proprietary codes, pointers, references to data stored in other memories, including other network locations, or information that is used by a function to calculate relevant data.

FIG. 5 functionally illustrates the processing element 716 and memory 704 as being within the same block, but the processing element 716 and memory 704 may instead include multiple processors and memories that may or may not be stored within the same physical housing. For example, some of the instructions 712 and data 708 may be stored on a removable CD-ROM and others may be within a read-only computer chip. Some or all of the instructions and data can be stored in a location physically remote from, yet still accessible by, the processing element 716. Similarly, the processing element 716 can include a collection of processors, which may or may not operate in parallel.

The computing device 700 may also include one or more modules 720. Modules 720 may comprise software modules that include a set of instructions, data, and other components (e.g., libraries) used to operate computing device 700 so that it performs specific tasks. For example, the modules may comprise scripts, programs, or instructions to implement one or more of the functions associated with the modules or components discussed in FIGS. 3 and 4. The modules 720 may comprise scripts, programs, or instructions to implement the process flow of FIGS. 1 through 4. For instance, the FormPaLI model may comprise one or more modules that cause the computing device to accept input as shown in FIG. 2 or 3 and provide the output provided in those figures.

Computing device 700 may also include one or more input/output interface 730. Interface 730 may receive a query and other data (e.g., document image) as discussed above and after processing output a response to the query and the document image with a bounding box. Each output port may comprise an I/O interface that communicates with local and wide area networks.

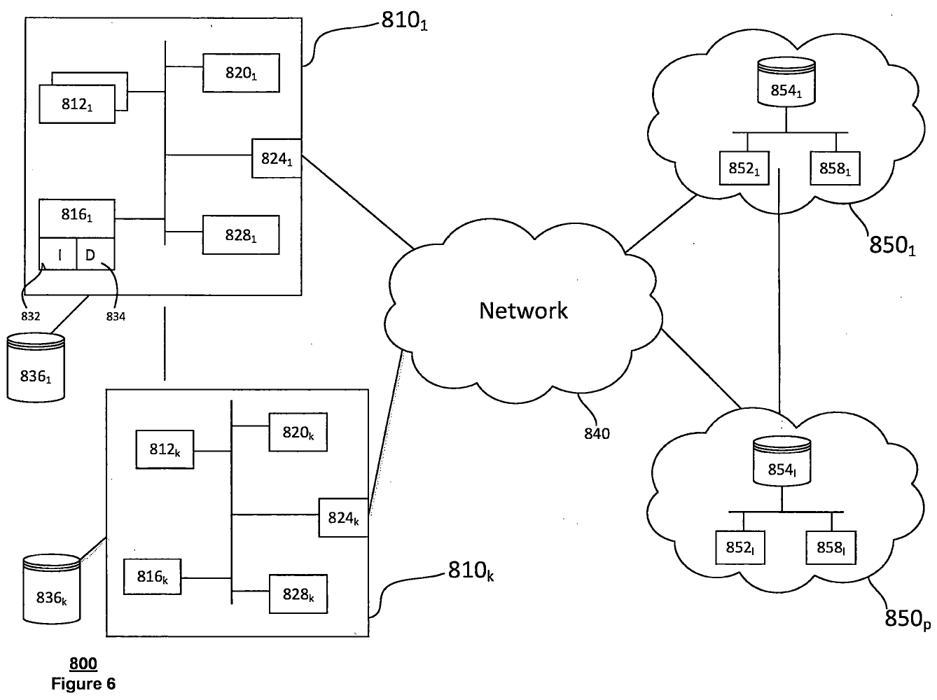

In some examples, the disclosed technology may be implemented as a system 800 in a distributed computing environment as shown in FIG. 6. System 800 includes one or more computing devices 810, which may comprise computing devices 810₁ through 810ₖ, storage 836, a network 840, and one or more cloud computing systems 850, which may comprise cloud computing systems 850₁ through 850ₚ. Computing devices 810 may comprise computing devices located at a customer location that makes use of cloud computing services such as Infrastructure as a Service (IaaS), Platform as a Service (PaaS), and/or Software as a Service (SaaS). For example, if a computing device 810 is located at a business enterprise, computing device 810 may use cloud systems 850 as a service that provides software applications (e.g., accounting, word processing, inventory tracking, etc., applications) to computing devices 810 used in operating enterprise systems. In addition, computing device 810 may access cloud computing systems 850 as part of its operations to perform query-based document extractions.

Computing device 810 may comprise a computing device as discussed in relation to FIG. 5. For instance, each of computing devices 810 may include one or more processors 812, memory 816 storing data 834 and instructions 832, display 820, communication interface 824, and input system 828. The processors 812 and memories 816 may be communicatively coupled as shown in FIG. 7. Computing device 810 may also be coupled or connected to storage 836, which may comprise local or remote storage, e.g., on a Storage Area Network (SAN), that stores data accumulated as part of a customer's operation. Computing device 810 may comprise a standalone computer (e.g., desktop or laptop) or a server associated with a customer. A given customer may also implement, as part of its business, multiple computing devices as servers. Memory 816 stores information accessible by the one or more processors 812, including instructions 832 and data 834 that may be executed or otherwise used by the processor(s) 812. The memory 816 may be of any type capable of storing information accessible by the processor, including a computing device-readable medium, or other medium that stores data that may be read with the aid of an electronic device, such as a hard drive, memory card, ROM, RAM, DVD or other optical disks, as well as other write-capable and read-only memories. Systems and methods may include different combinations of the foregoing, whereby different portions of the instructions and data are stored on different types of media.

Computing device 810 may also include a display 820 (e.g., a monitor having a screen, a touch-screen, a projector, a television, or other device that is operable to display information) that provides a user interface that allows for controlling the computing device 810. Such control may include, for example, using a computing device to cause data to be uploaded through input system 828 to cloud system 850 for processing, causing accumulation of data on storage 836, or more generally, managing different aspects of a customer's computing system. While input system 828 may be used to upload data, e.g., a USB port, computing system 800 may also include a mouse, keyboard, touchscreen, or microphone that can be used to receive commands and/or data.

The network 840 may include various configurations and protocols, including short-range communication protocols such as Bluetooth™, Bluetooth LE, the Internet, World Wide Web, intranets, virtual private networks, wide area networks, local networks, private networks using communication protocols proprietary to one or more companies, Ethernet, WiFi, HTTP, etc., and various combinations of the foregoing. Such communication may be facilitated by any device capable of transmitting data to and from other computing devices, such as modems and wireless interfaces. Computing device 810 interfaces with network 840 through communication interface 824, which may include the hardware, drivers, and software necessary to support a given communications protocol.

Cloud computing systems 850 may comprise one or more data centers that may be linked via high speed communications or computing networks. A given data center within system 850 may comprise dedicated space within a building that houses computing systems and their associated components, e.g., storage systems and communication systems. Typically, a data center will include racks of communication equipment, servers/hosts, and disks. The servers/hosts and disks comprise physical computing resources that are used to provide virtual computing resources such as VMs. To the extent that a given cloud computing system includes more than one data center, those data centers may be at different geographic locations within relatively close proximity to each other, chosen to deliver services in a timely and economically efficient manner, as well as provide redundancy and maintain high availability. Similarly, different cloud computing systems are typically provided at different geographic locations.

As shown in FIG. 6, computing system 850 may be illustrated as comprising infrastructure 852, storage 854, and computer system 858. Infrastructure 852, storage 854, and computer system 858 may comprise a data center within a cloud computing system 850. Infrastructure 852 may comprise servers, switches, physical links (e.g., fiber), and other equipment used to interconnect servers within a data center with storage 854 and computer system 858. Storage 854 may comprise a disk or other storage device that is partitionable to provide physical or virtual storage to virtual machines running on processing devices within a data center. For instance, storage 854 may comprise an element of the search backend as discussed above. Storage 854 may be provided as a SAN within the datacenter hosting the virtual machines supported by storage 854 or in a different data center that does not share a physical location with the virtual machines it supports. Computer system 858 acts as supervisor or managing agent for jobs being processed by a given data center. In general, computer system 858 will contain the instructions necessary to, for example, manage the operations requested as part of a synchronous training operation on customer data. Computer system 858 may receive jobs, for example, as a result of input (e.g., a search request) received via an application programming interface (API) from a user or customer.

Aspects of the disclosed technology may take the form of a method, process, apparatus, or system. Those examples may include one or more of the following features (e.g., F1 through F20):
F1. A process for querying one or more documents, comprising:
receiving a document query including a natural language query and information identifying one or more document images;
processing the document query in a machine learning model, the machine learning model being trained using language features and vision features for joint learning; and
generating an answer based on processing of the document query by the machine learning model, the answer including text and a bounding box indicating a location of the source of the answer.
F2. The process of F1, wherein the language features are associated with a large language model (LLM).
F3. The process of any one of F1 to F2, wherein the vision features are associated with a large vision model.
F4. The process of any one of F1 to F3, wherein the machine learning model is based on a language-image model.
F5. The process of any one of F1 to F4, wherein the model is pretrained on image-text tasks.
F6. The process of any one of F1 to F5, wherein the model is fine-tuned using one or more datasets and one or more tasks.
F7. The process of any one of F1 to F6, wherein the one or more datasets include key-value pair data, specific entity data or generic entity data.
F8. The process of any one of F1 to F7, wherein the model is pretrained to predict text in a bounding box specified by one or more polygon vertices; including for example two corner coordinates for an axis-aligned bounding box.
F9. The process of any one of F1 to F8, wherein the model uses machine learning inferences to make predictions on new data.
F10. The process of any one of F1 to F9, wherein the model uses GPUs or TPUs for inferencing.
F11. The process of any one of F1 to F10, wherein processing comprises applying optical character recognition (OCR) to the one or more document images.
F12. The process of any one of F1 to F11, wherein processing comprises partitioning the one or more document images into different regions.
F13. The process of any one of F1 to F12, wherein processing comprises resampling images associated with the different regions.
F14. The process of any one of F1 to F13, comprising verifying the answer against optical character recognition (OCR) generated text and a location parameter.
F15. The process of any one of F1 to F14, wherein the location parameters define the bounding box.
F16. The process of any one of F1 to F15, wherein the machine learning model is pretrained by masking spans of optical character recognition (OCR) serialized text and requesting the machine learning model to predict the spans of masked OCR serialized text.
F17. The process of any one of F1 to F16, wherein the machine learning model is pretrained by instructing the model to predict the line above, below, to the left and to the right of a given item of text.
F18. The process of any one of F1 to F17, wherein the natural language query comprises an audible question.
F19. A system for querying one or more documents, comprising:
one or more processing devices;
a memory storing instructions and coupled to the one or more processing devices, the instruction causing the one or more processing devices to:
receive a document query including a natural language query and information identifying one or more document images;
process the document query in a machine learning model, the machine learning model being trained using language features and vision features for joint learning; and
generate an answer based on processing of the document query by the machine learning model, the answer including text and a bounding box indicating a location of the source of the answer.
F20. The system of F19 wherein the instructions cause the one or more processing devices to process the document query by:
applying optical character recognition (OCR) to the one or more document images to produce OCR generated text;
partitioning the one or more document images into different regions; and
verifying the answer against the OCR generated text and a location parameter.

The disclosed technology may also comprise a computing device. The computing device may be configured to perform certain tasks in response to a prompt and provide output based on the prompt. The tasks can take the form of one or more instructions that cause the computing device to perform certain functions or are used to program the computing device to perform such functions. Those functions may comprise functions that implement the foregoing processing features discussed in the preceding paragraph above in relation to the process discussed above for querying one or more documents. Those processing features may comprise instructions that cause a processing element of the processing device to operate so as to apply the machine learning model in response to the prompt and provide the foregoing output.

The disclosed technology may also comprise a system. The system may include one or more of the foregoing computing devices that are programmed to perform the processing features discussed above. In this regard, the system may comprise a cloud computing system in which such computing devices are distributed in an architecture that allows customers to access or use the process for querying one or more documents as a service.

Although the technology herein has been described with reference to particular examples, it is to be understood that these examples are merely illustrative of the principles and applications of the disclosed technology. It is, therefore, to be understood that numerous modifications may be made to the illustrative examples and that other arrangements may be devised without departing from the scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as.” “including.” and the like, should not be interpreted as limiting the subject matter of the claims to the specific examples; rather, the examples are intended to illustrate only some but not all possible variations of the disclosed technology. Further, the same reference numbers in different drawings can identify the same or similar elements.

1. A process for querying one or more documents, comprising:
receiving a document query including a natural language query and information identifying one or more document images;
processing the document query in a machine learning model, the machine learning model being trained using language features and vision features for joint learning; and
generating an answer based on processing of the document query by the machine learning model, the answer including text and a bounding box indicating a location of the source of the answer.

2. The process of claim 1, wherein the language features are associated with a large language model (LLM).

3. The process of claim 1, wherein the vision features are associated with a large vision model.

4. The process of claim 1, wherein the machine learning model is based on a language-image model.

5. The process of claim 4, wherein the model is pretrained on image-text tasks.

6. The process of claim 5, wherein the model is tuned using one or more datasets and one or more tasks.

7. The process of claim 6, wherein the one or more datasets include key-value pair data, specific entity data or generic entity data.

8. The process of claim 4, wherein the model is fine-tuned to predict text in a bounding box specified by one or more polygon vertices.

9. The process of claim 8, wherein the model uses machine learning inferences to make predictions on new data.

10. The process of claim 9, wherein the model uses GPUs or TPUs for inferencing.

11. The process of claim 1, wherein processing comprises applying optical character recognition (OCR) to the one or more document images.

12. The process of claim 1, wherein processing comprises partitioning the one or more document images into different regions.

13. The process of claim 5, wherein processing comprises resampling images associated with the different regions.

14. The process of claim 1, comprising verifying the answer against optical character recognition (OCR) generated text and a location parameter.

15. The process of claim 14, wherein the location parameters define the bounding box.

16. The process of claim 1, wherein the machine learning model is pretrained by masking spans of optical character recognition (OCR) serialized text and requesting the machine learning model to predict the spans of masked OCR serialized text.

17. The process of claim 1, wherein the machine learning model is pretrained by instructing the model to predict the line above, below, to the left and to the right of a given item of text.

18. The process of claim 1, wherein the natural language query comprises an audible question.

19. A system for querying one or more documents, comprising:
one or more processing devices;
a memory storing instructions and coupled to the one or more processing devices, the instruction causing the one or more processing devices to:
receive a document query including a natural language query and information identifying one or more document images;
process the document query in a machine learning model, the machine learning model being trained using language features and vision features for joint learning; and
generate an answer based on processing of the document query by the machine learning model, the answer including text and a bounding box indicating a location of the source of the answer.

20. The system of claim 19 wherein the instructions cause the one or more processing devices to process the document query by:
applying optical character recognition (OCR) to the one or more document images to produce OCR generated text;
partitioning the one or more document images into different regions; and
verifying the answer against the OCR generated text and a location parameter.
